(19) United States
(12) Patent Application Publication
(10) Pub. No.: US 2025/0011551 A1
(43) Pub. Date: Jan. 9, 2025

(54) SILICONE RUBBER COMPOSITION WITH EXCELLENT BRAKE FLUID RESISTANCE AND BRAKE CALIPER PISTON BOOT MANUFACTURED USING THE SAME

(71) Applicants: HYUNDAI MOBIS CO., LTD., Seoul (KR); YOUNG SHIN TR CO., LTD., Changnyeong-gun (KR); HRS CO., LTD., Pyeongtaek-si (KR)

(72) Inventors: Kang Won SEO, Yongin-si (KR); Chi Hoon JO, Yongin-si (KR); Moo Jin CHOI, Yongin-si (KR); Hyun Hwa HONG, Yongin-si (KR); Sei Min SON, Yongin-si (KR); Sung Ho CHO, Yongin-si (KR); Jin Yeop KIM, Changnyeong-gun (KR); Han Jung SEO, Changnyeong-gun (KR); Yong Gi MIN, Pyeongtaek-si (KR); Dong Hwan KIM, Pyeongtaek-si (KR); Jin Su JANG, Pyeongtaek-si (KR); Jin Sung KIM, Pyeongtaek-si (KR)

(73) Assignees: HYUNDAI MOBIS CO., LTD., Seoul (KR); YOUNG SHIN TR CO., LTD., Changnyeong-gun (KR); HRS CO., LTD., Pyeongtaek-si (KR)

(21) Appl. No.: 18/643,210

(22) Filed: Apr. 23, 2024

(30) Foreign Application Priority Data
Jun. 28, 2023 (KR) 10-2023-0083440

(51) Int. Cl. C08J 5/04; C08K 5/5419

(52) U.S. Cl. CPC C08J 5/0405; C08K 5/5419; C08J 2383/04

(57) ABSTRACT

A silicone rubber composition containing 30 to 50 parts by weight of a reinforcing filler, 5 to 10 parts by weight of silicone oil, and 1 to 5 parts by weight of a hydrophobic surface modifier, based on 100 parts by weight of silicone gum, and a brake caliper piston boot manufactured by molding the same and having excellent brake fluid resistance.

### CROSS-REFERENCE TO RELATED APPLICATION

This application claims priority to and the benefit of Korean Patent Application No. 2023-0083440, filed on Jun. 28, 2023, the disclosure of which is incorporated herein by reference in its entirety.

### BACKGROUND

### 1. Field of the Invention

The present disclosure relates to a silicone rubber composition with excellent brake fluid resistance and a brake caliper piston boot manufactured by molding the same.

### 2. Discussion of Related Art

The brake caliper piston boot functions as a dust cover to prevent contact with the outside or the inflow of foreign substances when the caliper piston operates.

The caliper piston boot requires brake fluid resistance due to its role as the external seal of the brake caliper and its role in maintaining the hydraulic pressure of the internal brake fluid. In addition, depending on the caliper system, the sealing structure is different, and there is also a specification with a metal ring inserted, and for this reason, the rubber material must have excellent adhesion to the metal ring during molding and driving.

Silicone rubber (VMQ), which was previously used, was filled with silica and inorganic filler to increase the density, thereby suppressing the infiltration of hydrophobic oils (IRM902, IRM903, engine oil, and the like) into the rubber matrix and improving oil resistance.

This is effective when the silicone rubber is immersed in hydrophobic oil, but when it is immersed in a liquid containing ethylene glycol (C₄H₄ (OH)₂) as the main ingredient, such as brake fluid, it was not effective in suppressing infiltration, and problems such as a decrease in the mechanical strength of the rubber or expansion in volume occurred. In addition, in severe cases, the mechanical strength of the silicone rubber may decrease, causing damage such as breaking of the molded test piece.

In addition, in order to suppress the infiltration of the silicone rubber (VMQ), a method of increasing the density of the resin matrix is generally used by post-adding (filling) an inorganic filler, but this does not effectively suppress the infiltration in the case of hydrophilic oil.

In the compounding process, which is a silicone rubber manufacturing process, a portion of the surface of silica used as a reinforcing filler can be modified to be hydrophobic by adding silicone oil, but when a lot of oil is added, the plasticity is lowered and the product is manufactured in a soft state to the point where post-processing cannot proceed, so there is a limit to increasing hydrophobicity.

On the other hand, fluorine-based silicone rubber (FVMQ) can effectively suppress the decrease in mechanical strength, volume expansion, and damage to parts by suppressing infiltration even when immersed in a liquid containing ethylene glycol (C₄H₄ (OH)₂) as a main ingredient, such as brake fluid, due to its excellent oil resistance and chemical resistance, but because the price is 5 to 10 times higher than that of general silicone rubber (VMQ), there was a problem of deteriorating marketability when molding parts using fluorine-based silicone rubber (FVMQ).

In addition, EPDM material has excellent brake fluid resistance, but its heat resistance is inferior, so there is a problem that it is inferior to silicon at high temperatures.

As described above, in the case of piston boots using common silicone materials, the silicone rubber material is softened by ethylene glycol, which is the main component of brake fluid, which causes the molded material to break or its physical properties to deteriorate, and accordingly, there is a demand for the development of caliper piston boots made of silicone with improved brake fluid resistance.

### SUMMARY OF THE INVENTION

The present invention is directed to providing a silicone rubber composition with excellent brake fluid resistance and a brake caliper piston boot manufactured by molding the same.

One aspect of the present invention provides a silicone rubber composition including 30 to 50 parts by weight of a reinforcing filler, 5 to 10 parts by weight of silicone oil, and 1 to 5 parts by weight of a hydrophobic surface modifier, based on 100 parts by weight of silicone gum.

According to an embodiment, the hydrophobic surface modifier may be a trialkoxysilane, for example, phenyltrialkoxysilane.

According to an embodiment, the reinforcing filler may be dry silica or wet silica, and a specific surface area of the dry silica preferably ranges from 100 m²/g to 300 m²/g.

According to an embodiment, the silicone rubber composition may further include one or more additives selected from an antioxidant, a rust inhibitor, a surfactant, a dispersant, a thickener, and an anti-foaming agent.

Another aspect of the present invention provides a caliper piston boot including a cured product of the silicone rubber composition.

According to an embodiment, the caliper piston boot manufactured by molding the silicone rubber composition is characterized by a hardness before and after immersion in brake fluid at 150° C. for 70 hours, as a brake fluid resistance test, differs by 8 or less.

According to an embodiment, the caliper piston boot manufactured by molding the silicone rubber composition is characterized in that the tensile strength before and after immersion in brake fluid at 150° C. for 70 hours, as a brake fluid resistance test, differs by 30% or less, and an elongation before and after immersion in brake fluid at 150° C. for 70 hours, as a brake fluid resistance test, differs by 30% or less.

According to an embodiment, the caliper piston boot manufactured by molding the silicone rubber composition is characterized by a volume before and after immersion in brake fluid at 150° C. for 70 hours, as a brake fluid resistance test, differs by 5% or less.

### DETAILED DESCRIPTION OF EXEMPLARY EMBODIMENTS

Hereinafter, the present invention will be described in more detail with reference to embodiments and drawings. However, the following embodiments are provided by way of illustration to help the understanding of the present invention, and the scope of the present invention is not limited thereto. It should be understood that the present invention includes various modifications and can be embodied in many different forms, and all modifications, equivalents and substitutes are included in the spirit and scope of the present invention.

The terms used in the present application are only used to describe specific embodiments, and are not intended to limit the present invention. Singular expressions include plural expressions unless the context clearly dictates otherwise. In the present application, it should be understood that the terms “include(s)” or “have (has)” and the like are intended to specify the presence of stated features, numbers, steps, operations, components, parts or combinations thereof, but do not preclude the presence or addition of one or more other features, numbers, steps, operations, components, parts and combinations thereof.

Unless defined otherwise, all terms used herein, including technical or scientific terms, have the same meaning as commonly understood by one of ordinary skill in the art to which this invention belongs. Terms such as those defined in commonly used dictionaries should be interpreted as having a meaning consistent with the meaning in the context of the related art and should not be interpreted in an ideal or excessively formal meaning unless explicitly defined in the present application.

The silicone rubber composition according to an embodiment includes silicone rubber as a crystalline base resin. Common silicone rubber (VMQ) is a compound made by mixing a linear silicone polymer, a reinforcing filler, and silicone oil. The silicone rubber has excellent heat resistance, cold resistance, and electrical properties and is molded and used for various purposes. In addition, various properties may be exhibited by applying small amounts of additives such as antioxidants, rust inhibitors, surfactants, dispersants, thickeners, and anti-foaming agents to existing compounds.

The silicone rubber composition according to an embodiment of the present invention may include 30 to 50 parts by weight of a reinforcing filler, 5 to 10 parts by weight of silicone oil, and 1 to 5 parts by weight of a hydrophobic surface modifier, based on 100 parts by weight of silicone gum. A detailed description of each ingredient and material is as follows.

### <Silicone Gum>

The linear silicone polymer applied to solid silicone rubber is called silicone gum (GUM) and is a compound having the structure shown in Chemical Formula 1 below.

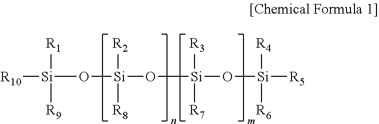

In the above formula, R₁ to R₁₀ are organic functional groups that are the same or different, and n and m are integers from 1 to 10,000 that are the same or different. Specifically, R₁ to R₁₀ are the same or different and each independently selected from the group consisting of hydrogen, a halogen, a substituted or unsubstituted C₁ to C₃₀ alkyl group, a substituted or unsubstituted C₂ to C₃₀ alkenyl group, a substituted or unsubstituted C₂ to C₂₄ alkynyl group, a substituted or unsubstituted C₂ to C₃₀ heteroalkyl group, a substituted or unsubstituted C₆ to C₃₀ aralkyl group, a substituted or unsubstituted C₅ to C₃₀ aryl group, a substituted or unsubstituted C₂ to C₃₀ heteroaryl group, a substituted or unsubstituted C₃ to C₃₀ heteroarylalkyl group, a substituted or unsubstituted C₃ to C₂₀ cycloalkyl group, a substituted or unsubstituted C₃ to C₂₀ heterocycloalkyl group, a substituted or unsubstituted C₃ to C₂₀ cycloalkenyl group, a substituted or unsubstituted C₃ to C₃₀ heteroaralkyl group, and a substituted or unsubstituted C₁ to C₂₀ heteroalkenyl group.

At least one of R₂, R₃, R₇ and R₈ is selected from a methyl group or a vinyl group.

### <Reinforcing Filler>

The reinforcing filler is silica and is used by selecting either dry silica or wet silica. Among these, it is preferable to use dry silica with a specific surface area ranging from 100 m²/g to 300 m²/g.

The silicone rubber composition according to an embodiment may include 30 to 50 parts by weight of a reinforcing filler based on 100 parts by weight of silicone gum. When the content of the reinforcing filler is less than 30 parts by weight, the mechanical strength of the composition is low and the composition becomes soft, causing a problem of poor elasticity and resilience, and when the content exceeds 50 parts by weight, the filler does not knead well and clumps up when kneading with silicone resin, creating a non-uniform composition, which causes poor mechanical properties, so it is suitable to use the filler in the above range.

### <Silicone Oil>

The silicone oil applied in the embodiments is organopolysiloxane oil, which is a compound having the following structure, and as a silica surface treatment agent, it suppresses the silica filler from forming hydrogen bonds with moisture in the air, thereby correcting the plasticity, and improving mixing and dispersibility.

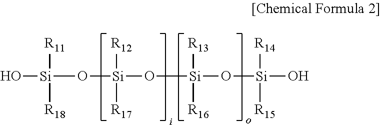

In the above Formula, R₁₁ to R₁₈ are the same or different organic functional groups, and 1 and 0 are the same or different integers from 1 to 1000. Specifically, R₁₁ to R₁₈ are the same or different and each independently selected from the group consisting of hydrogen, a halogen, a substituted or unsubstituted C₁ to C₃₀ alkyl group, a substituted or unsubstituted C₂ to C₃₀ alkenyl group, a substituted or unsubstituted C₂ to C₂₄ alkynyl group, a substituted or unsubstituted C₂ to C₃₀ heteroalkyl group, a substituted or unsubstituted C₆ to C₃₀ aralkyl group, a substituted or unsubstituted C₅ to C₃₀ aryl group, a substituted or unsubstituted C₂ to C₃₀ heteroaryl group, a substituted or unsubstituted C₃ to C₃₀ heteroarylalkyl group, a substituted or unsubstituted C₃ to C₂₀ cycloalkyl group, a substituted or unsubstituted C₃ to C₂₀ heterocycloalkyl group, a substituted or unsubstituted C₃ to C₂₀ cycloalkenyl group, a substituted or unsubstituted C₃ to C₃₀ heteroaralkyl group, and a substituted or unsubstituted C₁ to C₂₀ heteroalkenyl group.

At least one of R₁₂, R₁₃, R₁₆ and R₁₇ is selected from a methyl group or a vinyl group.

The silicone rubber composition according to an embodiment may include 5 to 10 parts by weight of silicone oil based on 100 parts by weight of silicone gum. When the content of silicone oil is less than 5 parts by weight, the mixing and dispersibility of a silica filler through silica surface treatment decreases, resulting in an increased plasticity and a non-uniform composition, which causes poor mechanical properties, and when the content exceeds 10 parts by weight, unreacted oil remains in the composition, which lowers the plasticity and reduces mechanical strength, making the composition soft and reducing elasticity and resilience, so it is suitable to use it within the above range.

### <Hydrophobic Surface Modifier>

In the embodiment, a large number of hydrophobic functional groups were imparted to the surface of silica, which is used as a reinforcing filler in the preparation of silicone rubber, to effectively prevent the infiltration of ethylene glycol (C₂H₄ (OH)₂), which is the main component of brake fluid, into the silicone rubber matrix.

Specifically, a trialkoxysilane represented by the following Chemical Formula 3 may be used as a hydrophobic surface modifier for silica.

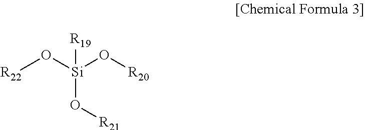

In the above formula, R₁₉ to R₂₂ are the same or different, and may each be independently selected from a methyl group, an ethyl group, and a phenyl group. For example, R₁₉ may be selected from a methyl group or a phenyl group, and at least one of R₂₀ to R₂₂ may be selected from a methyl group or an ethyl group.

Specific examples of alkyltrialkoxysilanes below include methyltrimethoxysilane, methyltriethoxysilane, phenyltrimethoxysilane, and phenyltriethoxysilane.

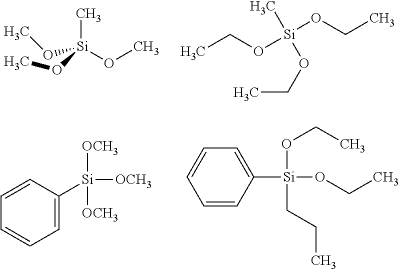

Among trialkoxysilanes, phenylalkoxysilane has excellent water repellency and may effectively block infiltration into the matrix by brake fluid, and even when the addition amount is increased to provide a large number of hydrophobic functional groups, it does not affect the plasticity, and a favorable plasticity may be maintained during post-processing and molding of parts, making it suitable for use as a surface modifier for silicone rubber compositions.

The silicone rubber composition according to an embodiment may include 1 to 5 parts by weight of a hydrophobic modifier based on 100 parts by weight of silicone gum. When the content of the hydrophobic modifier is less than 1 part by weight, there is a problem of not providing sufficient hydrophobic functional groups to block infiltration into the matrix by brake fluid, and when the content exceeds 5 parts by weight, there is a problem of decreased mechanical properties due to excess unreacted modifier and an increased product price due to expensive raw materials, which reduces marketability, so it is suitable to use it within the above range.

The silicone rubber composition according to an embodiment may include 30 to 50 parts by weight of a reinforcing filler, 5 to 10 parts by weight of silicone oil, and 1 to 5 parts by weight of a hydrophobic surface modifier, based on 100 parts by weight of silicone gum.

The hydrophobic surface modifier may be a trialkoxysilane, for example, phenyltrialkoxysilane.

The reinforcing filler may be dry silica or wet silica, and a specific surface area of the) dry silica preferably ranges from 100 m²/g to 300 m²/g.

The silicone rubber composition may further include one or more additives selected from antioxidants, rust inhibitors, surfactants, dispersants, thickeners, and anti-foaming agents.

A caliper piston boot with excellent brake fluid resistance may be manufactured by molding the silicone rubber composition.

The caliper piston boot manufactured by molding the silicone rubber composition is characterized by a hardness change rate of 8 or less and a volume change of 3% or less as a result of a brake fluid resistance test measured after immersion in brake fluid at 150° C. for 70 hours.

In addition, the caliper piston boot manufactured by molding the silicone rubber composition is characterized in that the tensile strength change and elongation change are 20% or less as a result of a brake fluid resistance test measured after immersion in brake fluid at 150° C. for 70 hours.

The present invention will be described in more detail below through examples and test examples.

### EXAMPLE

### Preparation of Silicone Rubber Composition

A silicone rubber composition for manufacturing a brake caliper piston boot was prepared by mixing 30 to 50 parts by weight of silica as a reinforcing filler, 5 to 10 parts by weight of silicone oil, and 1 to 5 parts by weight of phenylalkoxysilane as a hydrophobic surface modifier based on 100 parts by weight of silicone gum.

### Comparative Example 1

A silicone rubber composition including only silicone gum, silicone oil, and silica filler was prepared without including a surface modifier.

### Comparative Example 2

An oil-resistant silicone rubber composition was prepared by adding inorganic fillers such as aluminum oxide (Al₂O₃) and quartz powder along with silica as a reinforcing filler to the resin composition according to Comparative Example 1.

### Comparative Example 3

A silicone rubber composition was prepared using fluorine-based silicone rubber.

### Test Example

### Evaluation of Physical Properties of Molded Articles

After sufficiently plasticizing each uncured silicone rubber composition prepared according to the above example in a two-roll mill, 1 part by weight of organic peroxide (2,5-dimethyl-2,5-t-butylhexane peroxide, 45% paste) was added based on 100 parts by weight of the uncured silicone rubber composition and sufficiently dispersed. Afterward, the preform that had gone through a defoaming process was pressed in a forming mold at 170° C. for 10 minutes to form a sheet with a thickness of 2 mm and cured in a hot air circulation oven at 200° C. for 4 hours to produce a cured rubber product. The following physical properties were evaluated for the produced cured product and are shown in Table 1.
Hardness: Measured with Shore A durometer according to ASTM D 2240 or IRHD durometer according to ISO 48-2
Tensile strength: Measured according to ASTM D 412 standard
Elongation: Measured according to ASTM D 412 standard
Mooney viscosity: Measured for 6 minutes at a temperature of 50° C.
Curing time: Measured for 10 minutes at a temperature of 170° C.
Brake oil immersion (DOT) test: A standard test piece (25×50×2.0+0.01 mm) is prepared to measure the volume change according to the test method of ASTM D471 standard. After immersing in DOT3 oil at a temperature of 150° C. for 70 hours, the test piece is taken out and hardness change, tensile strength, elongation, and volume change are measured.

TABLE 1

| | | Com- | Com- | Com- | |
|---|---|---|---|---|---|
| | | parative | parative | parative | |
| Evaluation items | | Example 1 | Example 2 | Example 3 | Example |
| Specific gravity | | 1.15 | 1.12 | 1.16 | 1.12 |
| Plasticity | | 220 | 200 | 225 | 200 |
| Hardness | (Shore A) | 60 | 59 | 58 | 59 |
| Tensile | (kgf/cm²) | 72 | 84 | 105 | 104 |
| strength | | | | | |
| Elongation | (%) | 295 | 380 | 480 | 560 |
| Mooney | (Initial) | 37.9 | 31.8 | 35.7 | 29.2 |
| Viscosity | | | | | |
| | (ML1:00) | 29.9 | 25 | 25.5 | 24.7 |
| Curing | (Tc10) | 1:34 | 1:42 | 1:33 | 1:41 |
| time | (Tc90) | 3:12 | 4:27 | 4:15 | 3:30 |
| DOT Oil | Hardness | Cracks | −19 | −8 | −8 |
| | change | | | | |
| | Tensile | Cracks | −80 | −34 | −20 |
| | strength | | | | |
| | change (%) | | | | |
| | Elongation | Cracks | −55 | 22 | 20 |
| | change (%) | | | | |
| | Volume | 3.9 | 3.1 | 3.1 | 3 |
| | change (%) | | | | |

TABLE 2

| | Comparative | Comparative | |
|---|---|---|---|
| | Example 1 | Example 2 | Example |
| Brake fluid resistance | −10 | −11 | −6 |
| hardness change (IRHD) | | | |
| after aging brake fluid | | | |
| at 105° C. for 70 hr | | | |

The silicone rubber composition including the hydrophobic modifier according to the example has a high level of excellent mechanical strength due to its excellent resistance to infiltration into the matrix of the silicone rubber even after being immersed in a hydrophilic solution such as ethylene glycol (C₂H₄ (OH)₂), which is the main component of brake fluid.

In addition, by adding a silica hydrophobic modifier in the compounding process, it is possible to provide a large number of hydrophobic functional groups without increasing the amount of silicone oil commonly used, thereby preventing a decrease in plasticity due to silicone oil and preventing a decrease in work characteristics during a processing process.

In addition, it can be confirmed that the silicone rubber composition according to the example is economical because it can provide water repellency at a low production cost, and is suitable for manufacturing brake caliper piston boots because it has excellent brake fluid resistance and mechanical properties.

The brake caliper piston boot manufactured by molding the silicone rubber composition according to the present invention has excellent heat resistance and improved brake fluid resistance by applying a silicone material. In other words, the boot has excellent brake fluid (DOT) immersion resistance performance and can maintain mechanical performance even after immersion.

In addition, since excessive silicone oil is not added, it has the advantage of being able to correct plasticity to suit workability during processing and molding.

Meanwhile, effects of the present invention are not limited to the effects mentioned above, and other effects not mentioned will be clearly understood by those skilled in the art from the description above.

What is claimed is:

1. A silicone rubber composition comprising: based on 100 parts by weight of silicone gum,
30 to 50 parts by weight of a reinforcing filler;
5 to 10 parts by weight of silicone oil; and
1 to 5 parts by weight of a hydrophobic surface modifier.

2. The silicone rubber composition of claim 1, wherein the hydrophobic surface modifier is a trialkoxysilane.

3. The silicone rubber composition of claim 2, wherein the trialkoxysilane is phenyltrialkoxysilane.

4. The silicone rubber composition of claim 1, wherein the reinforcing filler is dry silica or wet silica.

5. The silicone rubber composition of claim 4, wherein the dry silica has a specific surface area ranging from 100 m²/g to 300 m²/g.

6. The silicone rubber composition of claim 1, further comprising one or more additives selected from an antioxidant, a rust inhibitor, a surfactant, a dispersant, a thickener, and an anti-foaming agent.

7. A caliper piston boot comprising a cured product of the silicone rubber composition of claim 1.

8. The caliper piston boot of claim 7, wherein a hardness before and after immersion in brake fluid at 150° C. for 70 hours, as a brake fluid resistance test, differs by 8 or less.

9. The caliper piston boot of claim 7, wherein a tensile strength before and after immersion in brake fluid at 150° C. for 70 hours, as a brake fluid resistance test, differs by 30% or less, and an elongation before and after immersion in brake fluid at 150° C. for 70 hours, as a brake fluid resistance test, differs 30% or less.

10. The caliper piston boot of claim 7, wherein a volume before and after immersion in brake fluid at 150° C. for 70 hours, as a brake fluid resistance test, differs by 5% or less.
